(19) United States
(12) Patent Application Publication
(10) Pub. No.: US 2003/0177096 A1
(43) Pub. Date: Sep. 18, 2003

(54) Mapped website system and method

(76) Inventors: John T. Trent, JR., Nashville, TN (US); John D. Leins, Nashville, TN (US)

Correspondence Address: DICKSTEIN SHAPIRO MORIN & OSHINSKY LLP, 2101 L STREET NW, WASHINGTON, DC, 20037-1526, US

(21) Appl. No.: 10/366,526

(22) Filed: Feb. 14, 2003

Related U.S. Application Data
(60) Provisional application No. 60/356,125, filed on Feb. 14, 2002.

(51) Int. Cl. G06F 17/60

(52) U.S. Cl. 705/50

(57) ABSTRACT

An website, which may be an Internet, intranet, or extranet site, is designed to permit users to quickly navigate to a desired virtual location and then access the document or other requested material with minimum interruption and maximum speed. More specifically, the website is navigated in a conceptually similar fashion to how tasks and objects would be accessed in the physical world. For example, each web page may present a view of a different room. Each room has pictures of certain features that are selectable. These parallel the actions a user would take in the physical location to perform a function. For example, to access a document, the user opens a folder by clicking on it. Additionally, each page of the website share a number of common features. These include a help/information icon for providing a help page to the user, a site map for providing miniature map of the web site, and directional arrows for showing navigational links to other rooms. The website can be hosted by any known architectural configuration that is capable of supporting the functions desired for the website.

This application claims priority to U.S. provisional patent application No. 60/356,125, filed Feb. 14, 2002, the contents of which are incorporated by reference.

### FIELD OF INVENTION

The present invention relates an website. More specifically, the website of the present invention is created to provide users access to functions and processes, including business processes, in an environment that has common user interface elements and which is a virtual representation of a physical location.

### BACKGROUND OF THE INVENTION

Many Internet, intranet, or extranet website interfaces are difficult to navigate and feature a combination of incompatible or clashing user interface elements. For example, many websites have interface may include text based headings, subtext, streaming texts, or may include links incorporating pictures and/or cartoon-like characters. Some interfaces may even include pop-up windows and pictures on the margins. The use of a plurality of available user interface elements makes it hard for a user to determine where he can go to access desired information quickly. Additionally, many websites may interface to applications which are document intensive, or use which specialized vocabulary, further complicating a user's desire to quickly locate desired information. It is therefore not surprising that many people and organizations have spent small fortunes on building websites that are simply not used, or under-used. Accordingly, there is a need and desire for an method and apparatus for permitting a website user to quickly navigate to a desired virtual location, and then access the document or other material with minimal interruption and maximum speed.

It is an object therefore of the present invention to provide a website, such as an internet, intranet, or extranet website, where tasks and objects are accessed in a virtual fashion that is conceptually similar to the way these would be accessed in the physical world. It is anticipated that such an website can be hosted by any known architectural configuration that is capable of supporting the functions desired for the website. Additionally, it is contemplated that the website can be applied to any environment that lends itself functionally to defining tasks by physical location. Such an environment would provide a visual cue to the user about the functions that are expected to be performed for that physical location in which the desired function occurs. The website is also configurable and extensible.

### SUMMARY OF THE INVENTION

The present invention is directed to a method and apparatus for providing a website designed to permit users to quickly navigate to a desired virtual location and then access the document or other requested material with minimum interruption and maximum speed. More specifically, the present invention provides a website where tasks and objects are accessed in a virtual fashion that is conceptually similar to the way corresponding objects would be accessed in the physical world. For example, each web page may present a view of a different room. Each room has pictures of certain features that are selectable. These parallel the actions a user would take in the physical location to perform a function. For example, to access a document, the user opens a folder by clicking on it. Additionally, each page of the website share a number of common features. These include a help/information icon for providing a help page to the user, a site map for providing miniature map of the web site, and directional arrows for showing navigational links to other rooms. The website can be hosted by any known architectural configuration that is capable of supporting the functions desired for the website.

### DESCRIPTION OF THE DRAWINGS

The foregoing and other advantages and features of the invention will become more apparent from the detailed description of exemplary embodiments of the invention given below with reference to the accompanying drawings in which:

FIG. 1 is in illustration of a computing system;

FIG. 2 is an illustration of a web page depicting a reception room;

FIG. 3 is an illustration of a log on screen;

FIG. 4 is an generic illustration of a room;

FIG. 5 is an illustration of a waiting room;

FIG. 6 is an illustration of a hall;

FIG. 7 is an illustration of a conference room;

FIG. 8 is an illustration of an office;

FIGS. 9A and 9B are illustrations of an office including the right (FIG. 5A) and left (FIG. 5B) file drawer objects;

FIG. 10 is an illustration of an office including the calendar object;

FIG. 11 is an illustration of an office including the rolodex object;

FIG. 12 is an illustration of an office including the in box object;

FIG. 14 is an illustration of an office including the file folder object; and

FIG. 15 is an illustration of an office including the computer object.

### DETAILED DESCRIPTION OF THE INVENTION

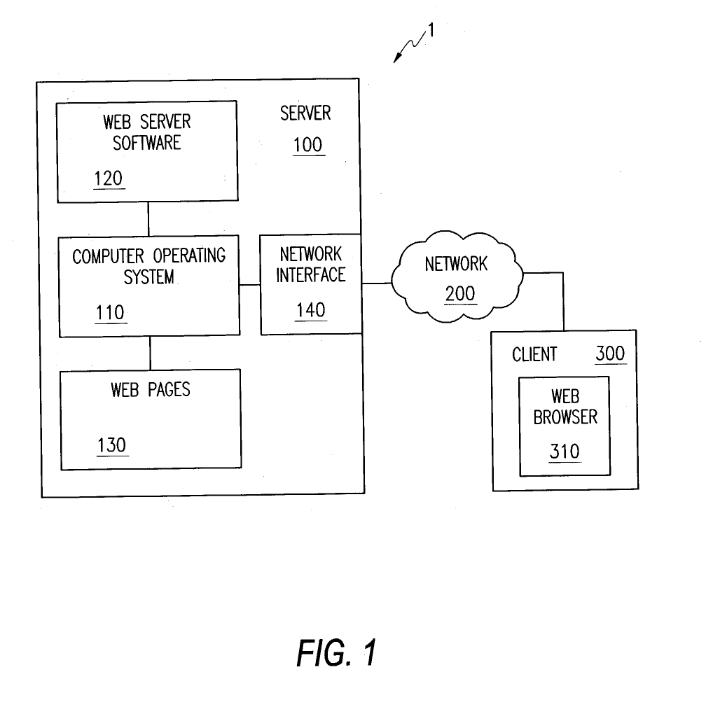

Now referring to the drawings, where like reference numerals designate like elements, there is shown in FIG. 1, a computer system 1 comprising a server 100, a network 200, and client 300. The server 100 includes an operating system 110, web server software 120, and web pages 130, and a network interface 140. The operating system coordinates the activities of the computer hardware and software by providing services to the web server software 120 (which may include applications in addition to a web server, such as databases or parsers) and operating the network interface 140. The web pages 130 of the website of the present invention may include both client-side and server-side code.

The server 100 and its associated components may be any sort of ordinary computer system capable of providing web hosting using standard HTML, ASP, and Flash, and any other helper application which may be required on a specific website. For example, in one exemplary embodiment, Microsoft Word document assembly and management is required. Document assembly is performed using an application called GhostFill and Microsoft's SQL Server, while document management is performed using the Hummingbird document management system. The present invention may be implemented on any computer hardware which using Microsoft Windows 2000 or Windows NT server and Microsoft's Internet Information Server (IIS) web server. Alternatively, other operating systems and software, such as the Linux operating system and the Apache web server, may also be used.

The network interface 140 couples the server to a network 200, which, depending upon the requirements of the website, may be a local area network (LAN), a wide area network (WAN), the Internet, or a virtual network. The network 200 may be a public network, or it may be a private network. At least one client computer 300 is also coupled to the network 200. The client computer includes a web browser 310, which in one exemplary embodiment is Microsoft's Internet Explorer (at least version 5.0).

First Embodiment

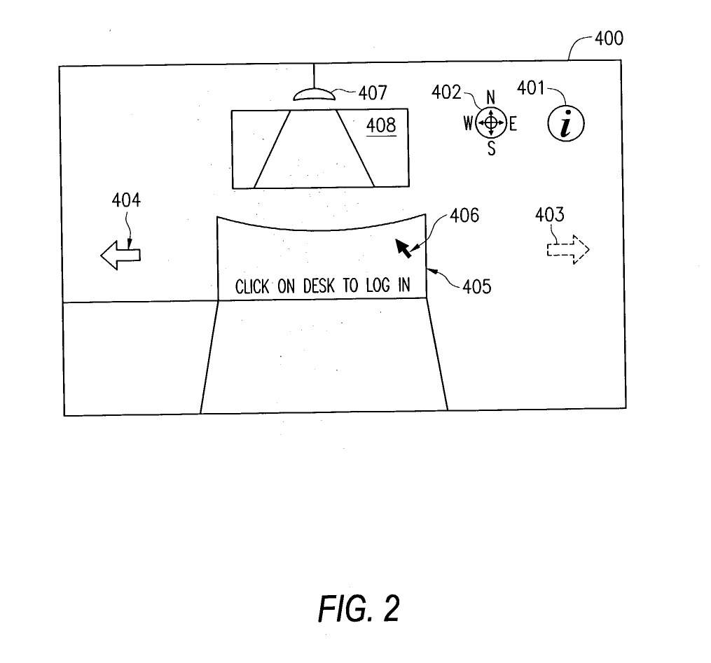

The first exemplary embodiment of the present invention is a law firm extranet website intended for use by attorneys (“lawyer user”), clients (“client user”), and administrators (“administrator user”) of the law firm. A user of the website is briefly presented with the logo of the law firm, and then taken to a entry page. Now referring to FIG. 2, the entry page takes the form of a receptionists area of a law firm. The receptionists area is a room which includes a receptionist's desk 406, a logo of the firm 408, and a light fixture 407 which can be toggled on or off 407. The desk 406 is a link which launches the log-in process. Additionally, if the user rolls his mouse pointer over the receptionist desk, pop-up text describing the link can appear. A suitable pop-up text may be, for example, “Click on the receptionist desk to log in.”

FIG. 2 also illustrates certain common user interface features used throughout the website. Theses include navigation arrows 403, 404 which are used to indicate links which moves the user from one room to another room in the website. In FIG. 2, arrow 403 is drawn with dotted lines to indicate that some arrows may not be drawn unless a user has logged into the system. This may be used to implement a security feature, so that users which have not yet logged in (i.e., unauthenticated users) can only navigate to “public” pages of the website. Once a user has logged in, all navigation arrows will be drawn.

Another commonly seen user interface feature illustrated in FIG. 2 is the Information/Help button 401, which is drawn by default at the same location of every page of the website. In one exemplary embodiment, the Information/Help button 401 is drawn in the upper right corner of each page. If the user selects the Information/Help button 401, the user is presented with helpful information regarding the current page. As with the case of the arrows, if a user has not yet logged in, the contents of the help message may be altered for non-logged-in users.

Finally, the site map button 402 is also a commonly seen user interface feature illustrated in FIG. 2. The site map button 402 can be configured so that it does not become visible until a user has successfully logged in. Pressing the site map button brings up a site map of the website. In one exemplary example, the site map a miniature map of the physical layout of the website. A user may pick a location in the site map and click on that portion to move to that page.

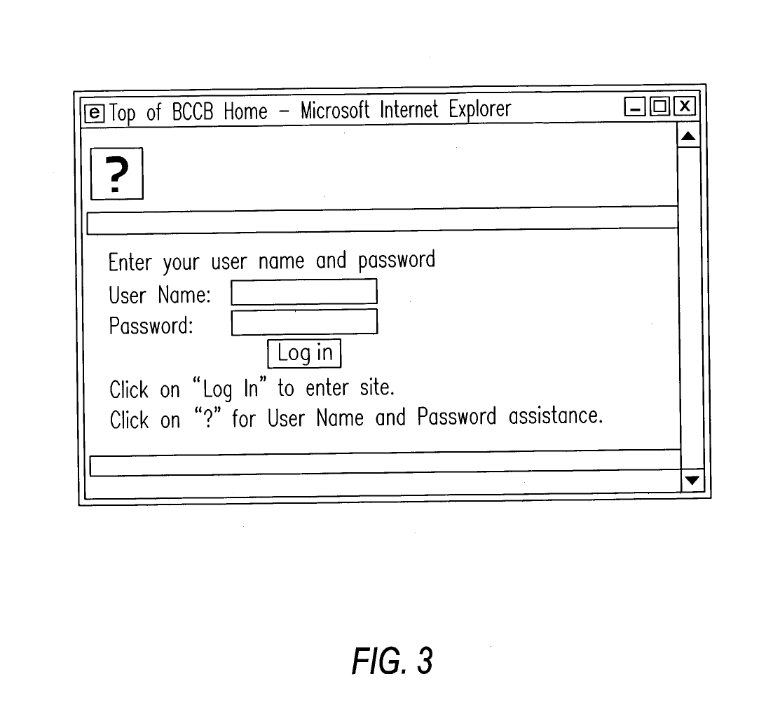

Navigation through the website is done via a series of web pages, each depicting a different room of the virtual law firm. All rooms including drawings or pictures of certain features that are selectable, and which correspond to real objects. These parallel the actions a user would take in the physical location to perform a function. For example, the receptionist room has a receptionist's desk where users can log into the system. The user clicks on the receptionist's desk, a window (FIG. 3) appears requesting the client user's log in ID and password. Upon submitting valid information, the log-in window disappears and the client user is returned to the virtual reception area. Now that the user is logged in, the previously hidden navigation arrows 403 and site map button 402 become visible and usable.

The user can now use the navigation arrows 403, 404 to navigate from room to room in the virtual law firm. Each room type may have different objects which can be selected in order to further navigate the user, and/or present the user with requested information. Different rooms may include similar types of object, but the information accessed by each similar type object may be different.

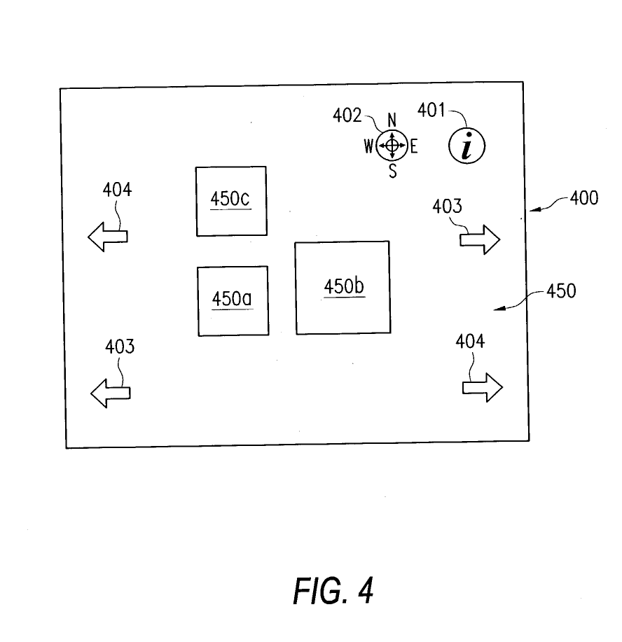

In the exemplary embodiment, the following types of rooms are contemplated: Waiting Room, Hall, Conference Room and, Office. Referring now to FIG. 4, a generic illustration of a room 450 is illustrated. As previously noted, while each room 450 may be a different type, all rooms share certain common features. Room 450 therefore includes the navigation arrows 403,404, Help/Information button 401, and the site map button 402. Each room also includes a plurality of objects 450a, 450b, 450c, which vary in number and size in accordance to room type. The composition of the plurality of objects 450a, 450b, 450c which make up the different types of rooms of the website are described below:

A. Waiting Room

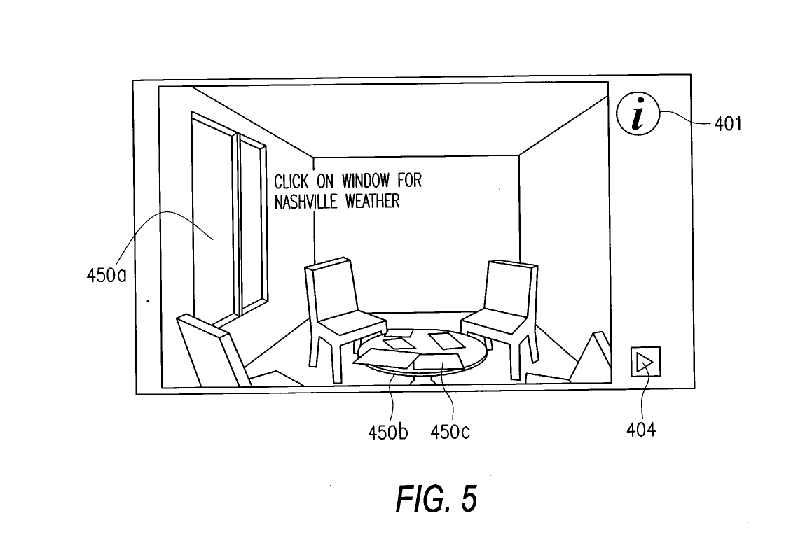

The waiting room (FIG. 5) is a public room and can therefore be accessed via navigation arrows 404 from other public rooms without requiring a user to log into the website. For example, the waiting room might be accessible from the receptionist room. The objects 450a, 450b, 450c in the waiting room may include a window, which if selected presents the user with generic information. In one exemplary embodiment, selecting the window presented the user with weather conditions and forecast for the law firm. Other objects may include tables, which if selected may reveal publications, periodicals, press releases, and other objects, which if selected, would present the user with data.

B. Hall

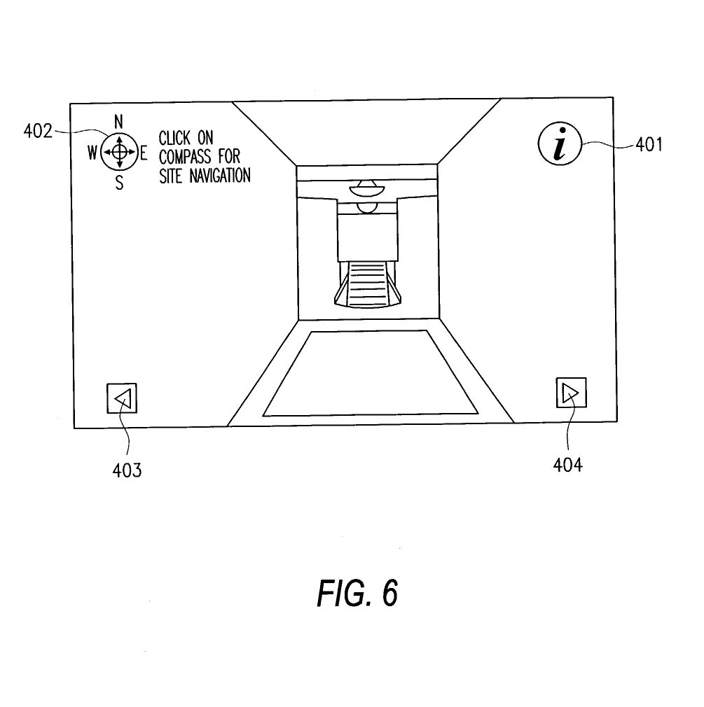

The hall (FIG. 6) is a room used for moving through the office. The most general hall include no additional objects 450a, 450b, 450c, and merely consists of links (e.g., navigation arrows 403, 404) to other rooms. However, some halls may include objects 450a, 450b, 450c similar to those found in the waiting room.

C. Conference Room

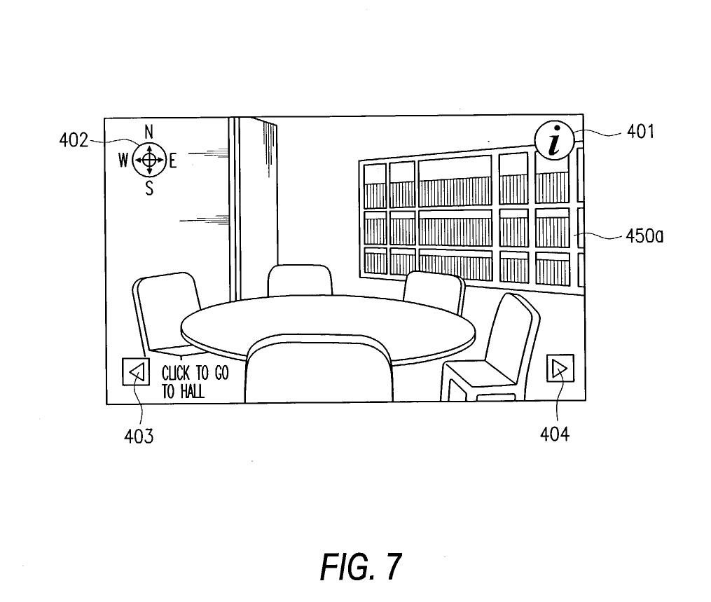

The conference room (FIG. 7) has an cabinet object 450a. Selecting the cabinet 450a causes a door of the cabinet to open and a user is presented with a list of links, each of which is customizable either by the client user, the lawyer user, or the administrative user, for a particular user or group of users. The specific links are customizable and definable when a particular user is granted access to the system. Upon selecting a link, a new window opens up and the user is able to access the linked site. When the window is closed and the link selection list is closed, an animation process closes the cabinet door.

D. Office

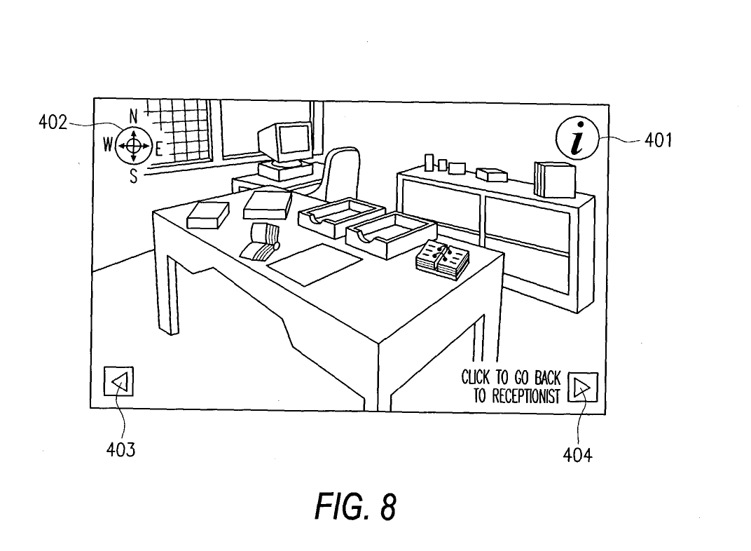

The office (FIG. 8) is where most of the business processes are accessed and is the most complex page on the website of the first embodiment. It has many features, including file drawers, calendars, rolodexes, In Boxes, Out Boxes, File Folders, and Computers. Each of these objects are described in greater detail below:

1. File Drawers

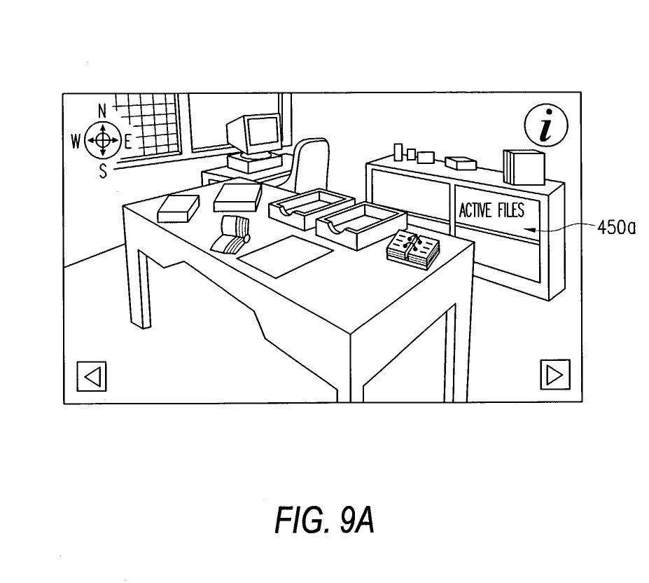

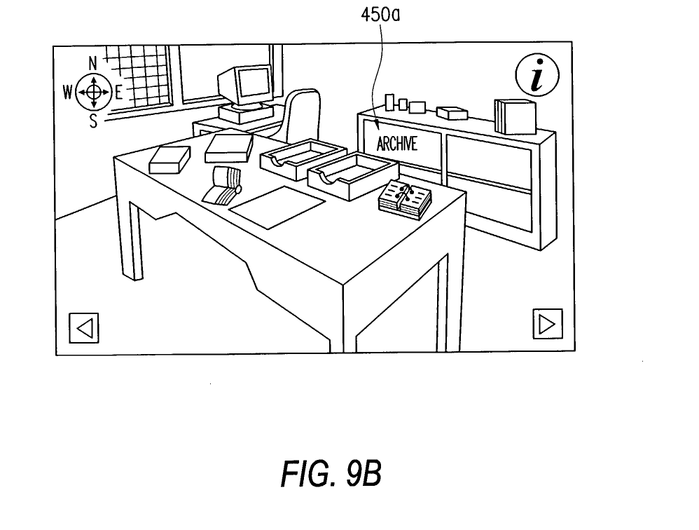

Referring now to FIGS. 9A and 9B, the file drawers are animated objects (the drawers open and shut) and are selectable. In one exemplary embodiment, the right file (FIG. 9A) drawer allows a logged in client user or lawyer user to pick a specific active project from a list that he/she has been authorized to access. The system remembers the last project the person may have accessed automatically upon log-in, but a single user may have access to multiple active projects. The left file drawer (FIG. 9B) permits the client or lawyer user to access archived projects which are no longer active. These archived projects are presented as a list to the user. Selecting a project determines what other documents and information is available, all of which are associated with the particular project in question. In addition to selecting projects, the attorney user can add, edit and delete projects at this location in the website.

2. Calendar

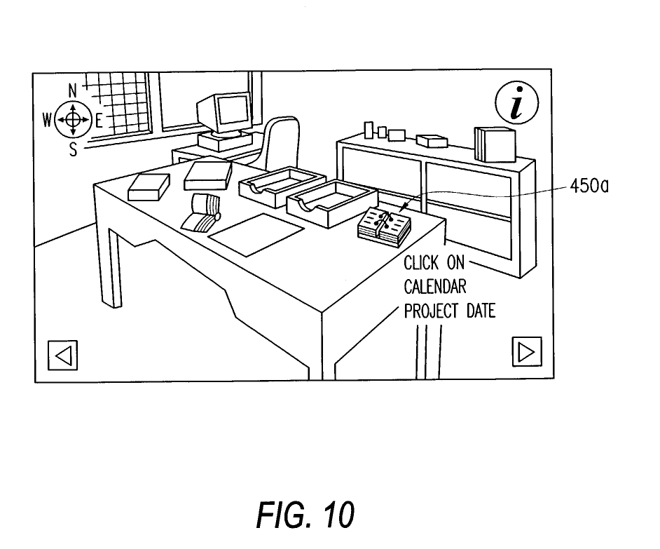

Referring now to FIG. 10, the calendar lets an attorney user define a list of project tasks and target dates for projects. When other users select this link they can observe, but not change this list.

3. Rolodex

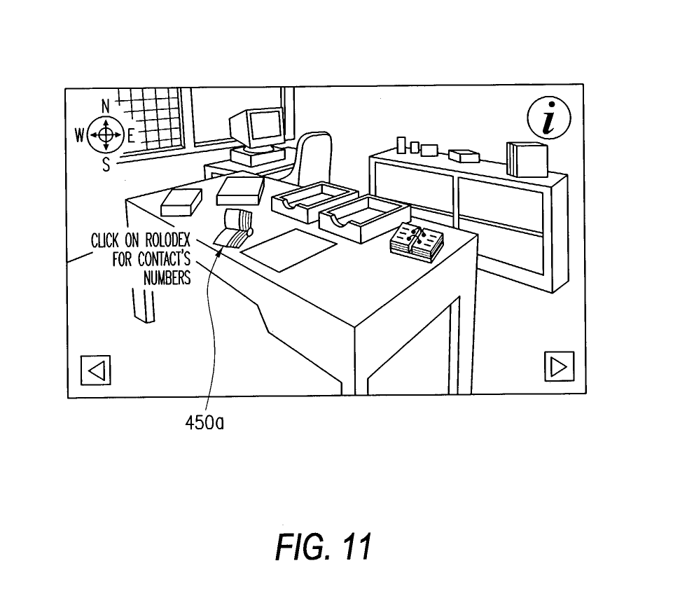

Referring now to FIG. 11, the Rolodex contains the names and demographic information for all individuals associated with the selected project. It also serves as a site for generating e-mails to any one of these individuals.

4. In Box

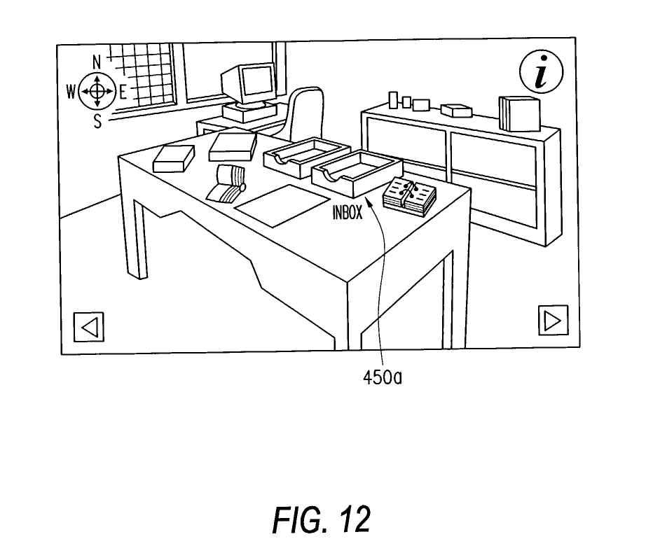

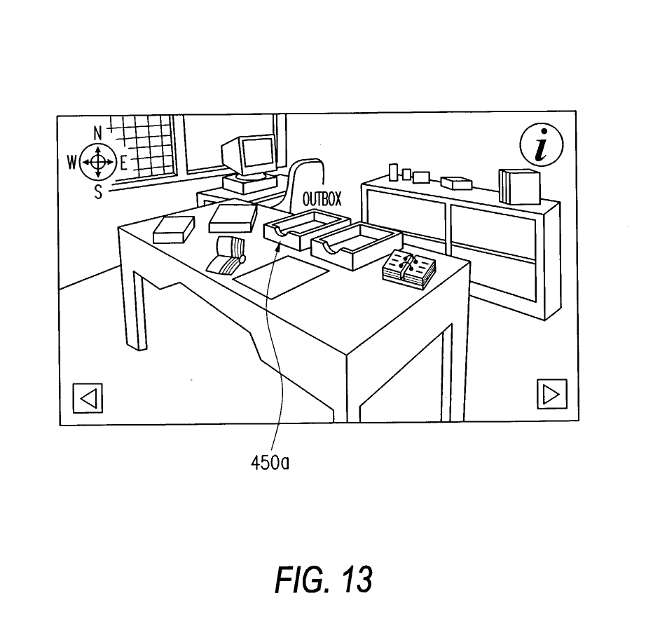

Referring now to FIG. 12, the In Box when selected, shows a list of tasks awaiting completion for the selected project. The list is editable by attorney users and is viewable by everyone else logged into the website (e.g. client users, administrative users).

5. Out Box

Referring now to FIG. 13, the Out Box, when selected, shows a list of completed tasks for the selected project. The list is editable by attorney users and viewable by everyone else who is logged in.

6. File Folder

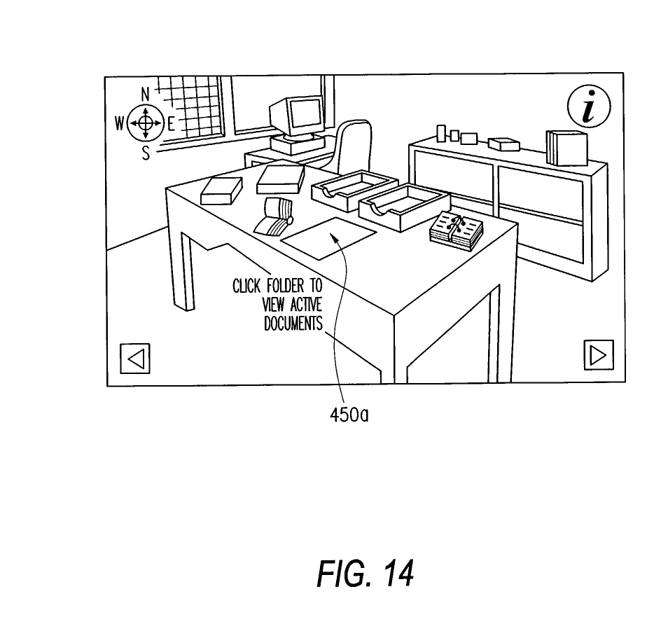

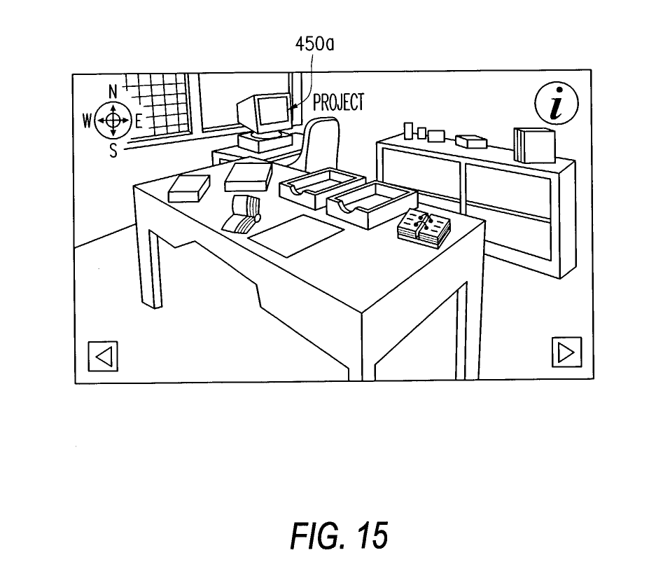

Referring now to FIG. 14, the File Folder, when selected opens to a window which presents all the documents which have been placed in the law firm's document management system and specifically made visible to client users and attorney users. These documents have been assigned permissions by attorney users which allow the various parties having access to the system overall and to a project specifically to view or check them out, according to their designated status. Documents are selected by clicking on links.

7. Computer

Referring now to FIG. 11, the Computer is a clickable area which brings up various options, depending on whether the user is an attorney, a client, or another type of user outside of the law firm (e.g. opposing counsel). Outside users have the option on this screen to update their personal information. In addition to editing their own personal information, attorney users are presented with the options to add users, add projects, assign users to projects, associate project names to client/matter numbers and archive projects when selecting the Computer.

Users also have the option to access a link which presents a data intake screen for an automated document assembly process specific to each project. The user is presented with either a virtual document of the type they wish to produce or a series of questions which will allow one or multiple documents to be produced. In either case, additional documents are automatically generated based on the input. Typically all or most documents required for a particular transaction would be automatically generated based on the user-supplied answers. The completed documents are then automatically made available in a minute or two inside the File Folder in the virtual office. These document can be viewed or checked out.

Second Embodiment

In a second embodiment, a website interface can be designed to change a present text based interface to one that a person navigates based upon a virtual representation of the physical world. For example, if a user is attempting to learn about the admissions process for a University through its website, rather than reading a great deal of text, the user could view a virtual three dimensional representation of the University. This website can provide a two dimensional map of the campus through the previously described compass function. Alternatively the user can virtually stroll through the three dimensional recreation of the University using the arrow icons as described above. Upon locating the admissions office building, the user clicks open the door and on the table are desks with admissions materials to be down-loaded (e.g. admissions forms, contacts, information materials).

Third Embodiment

Another embodiment of the invention involves online shopping. Using the principles set forth above, a website can be designed where a user could walk (navigate) through a store and see on the wall bicycles or camping gear. If the user were looking for a bicycle or camping gear, he/she would then click on the desired item and go to that part and see its representation. The user can also click on the bike picture to see all the bicycles that are for sale. A sale can then occur. Afterwards, the user is returned to a physical picture of the store, where they can click on the checkout person, which brings the user to the screen that asks for personal information. The user then exits the store.

Improvements can also be made in the way that purchases are counted. For example, the user often clicks on the shopping cart to put some things in there but has no easy way of determining what was in the cart. Also, the user may have completed information in the store's check-out process and then decide that he/she wants something else. In most websites, the user has to back up to an earlier screen that shows the shopping cart. In that instance, the user loses everything that was just typed in and has to start all over again. In the present embodiment this problem is prevented because the user can go to his/her physical cart which contains all of the data. After the cart is modified, the user can return to the other part of the store using the previously described map function.

The present invention uses scanned pictures, or photographs of the physical world to show where the user is going with the use of the mouseover function (which means it gives an indication of what happens if you use the mouse over that particular point), or through keystrokes. However, the present invention could be accomplished through drawings, and through cartoon-like figures (similar to the way computer games are constructed). An example of a drawn website application is a store-front created through drawing which would be like a main street with residential or commercial locations.

The website can also be personalized so that if the application were for a loan process, for example, the office could be branded for the particular customer's business. Additionally, the website can be used to exploit physical structures more logically in a virtual environment. Therefore, if the multiple floors of a building exist in the physical world, they could be represented in a virtual three dimensional form with only the relevant rooms being shown. That makes the interface simple and intuitive.

While the invention has been described in detail in connection with the exemplary embodiment, it should be understood that the invention is not limited to the above disclosed embodiment. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

What is claimed as new and desired to be protected by Letters Patent of the United States is:

1. A method of providing a user interface comprising a plurality of elements, said user interface to be displayed by a client program, said method comprising:
providing at least one public web page for all users; and
providing at least one private web page for users who have been authenticated;
wherein
each of said at least one public web page and each of said at least one private web page has at least one common element; and
each of said public and private web pages respectively has at least one page specific element, with said at least one page specific element forming a three dimensional depiction of a virtual workspace.

2. The method of claim 1, wherein said at least one common element is chosen from a set comprising:
an information/help icon;
a site map icon; and
a navigation arrow icon.

3. The method of claim 2, wherein at least one common element is visible only after a user has been authenticated.

4. The method of claim 1, wherein said at least one public and at least one private web page each depict a different room of a virtual workspace.

5. The method of claim 4 wherein each room of said virtual workspace has an respective room type; and wherein said set of room type comprises, a receptionist's room;
a waiting room;
a hallway;
a conference room; and
an office.

6. The method of claim 5, wherein said receptionist's room comprises a page specific element for presenting a user authentication form.

7. The method of claim 6, wherein said page specific element is a receptionist's table.

8. The method of claim 5, wherein said conference room comprises a page specific element for displaying a list of links.

9. The method of claim 8, wherein said page specific element is a cabinet.

10. The method of claim 5, wherein said office comprises at least one page specific element chosen from a set comprising:
a file drawer, for permitting a user to set a selected project from a list of active or inactive projects;
a calendar, for permitting a user to browse and to set, his own tasks and deadlines and for a user to browse at least another user's tasks and deadlines;
a rolodex, for permitting a user to search for demographic information by name;
an in box, for browsing a list of tasks awaiting completion for the selected project;
an out box, for browsing a list of completed task for the selected project;
a file folder, for browsing a documents associated with the selected project; and
a computer, for presenting controls to administer the website.

11. A system of providing a user interface comprising a plurality of elements, said user interface to be displayed by a client program, the system comprising:
a computer;
web pages; and
application software;
wherein said application software
serves at least one public web page for all users; and
serves at least one private web page for users who have been authenticated;
wherein
each of said at least one public web page and each of said at least one private web page has at least one common element; and
each of said public and private web pages respectively has at least one page specific element, with said at least one page specific element forming a three dimensional depiction of a virtual workspace.

12. The system of claim 11, wherein said at least one common element is chosen from a set comprising:
an information/help icon;
a site map icon; and
a navigation arrow icon.

13. The system of claim 12, wherein at least one common element is visible only after a user has been authenticated.

14. The system of claim 11, wherein said at least one public and at least one private web page each depict a different room of a virtual workspace.

15. The system of claim 14 wherein each room of said virtual workspace has an respective room type; and wherein said set of room type comprises,
a receptionist's room;
a waiting room;
a hallway;
a conference room; and
an office.

16. The system of claim 15, wherein said receptionist's room comprises a page specific element for presenting a user authentication form.

17. The system of claim 16, wherein said page specific element is a receptionist's table.

18. The system of claim 15, wherein said conference room comprises a page specific element for displaying a list of links.

19. The system of claim 18, wherein said page specific element is a cabinet.

20. The system of claim 15, wherein said office comprises at least one page specific element chosen from a set comprising:
a file drawer, for permitting a user to set a selected project from a list of active or inactive projects;
a calendar, for permitting a user to browse and to set, his own tasks and deadlines and for a user to browse at least another user's tasks and deadlines;
a rolodex, for permitting a user to search for demographic information by name;
an in box, for browsing a list of tasks awaiting completion for the selected project;
an out box, for browsing a list of completed task for the selected project;
a file folder, for browsing a documents associated with the selected project; and
a computer, for presenting controls to administer the website.

21. A computer readable storage medium, which when executed by a computer system causes the computer system to providing a user interface comprising a plurality of elements to be displayed by a client program, comprising:
web pages; and
application software;
wherein said application software, when executed by the computer system, cause the computer system to,
serve at least one public web page for all users; and
serve at least one private web page for users who have been authenticated;
wherein
each of said at least one public web page and each of said at least one private web page has at least one common element; and
each of said public and private web pages respectively has at least one page specific element, with said at least one page specific element forming a three dimensional depiction of a virtual workspace.

22. The computer readable storage medium of claim 21, wherein said at least one common element is chosen from a set comprising:
an information/help icon;
a site map icon; and
a navigation arrow icon.

23. The computer readable storage medium of claim 22, wherein at least one common element is visible only after a user has been authenticated.

24. The computer readable storage medium of claim 21, wherein said at least one public and at least one private web page each depict a different room of a virtual workspace.

25. The computer readable storage medium of claim 24 wherein each room of said virtual workspace has an respective room type; wherein said set of room type comprises,
a receptionist's room;
a waiting room;
a hallway;
a conference room; and
an office.

26. The computer readable storage medium of claim 25, wherein said receptionist's room comprises a page specific element for presenting a user authentication form.

27. The computer readable storage medium of claim 26, wherein said page specific element is a receptionist's table.

28. The computer readable storage medium of claim 25, wherein said conference room comprises a page specific clement for displaying a list of links.

29. The computer readable storage medium of claim 28, wherein said page specific element is a cabinet.

30. The computer readable storage medium of claim 25, wherein said office comprises at least one page specific element chosen from a set comprising:
a file drawer, for permitting a user to set a selected project from a list of active or inactive projects;
a calendar, for permitting a user to browse and to set, his own tasks and deadlines and for a user to browse at least another user's tasks and deadlines;
a rolodex, for permitting a user to search for demographic information by name;
an in box, for browsing a list of tasks awaiting completion for the selected project;
an out box, for browsing a list of completed task for the selected project;
a file folder, for browsing a documents associated with the selected project; and
a computer, for presenting controls to administer the website.
